(19) United States
(12) Patent Application Publication
(10) Pub. No.: US 2026/0315979 A1
(43) Pub. Date: Oct. 15, 2026

(54) POWDER RECOVERY DEVICE AND CONTROL METHOD OF POWDER RECOVERY DEVICE

(71) Applicant: MITSUBISHI HEAVY INDUSTRIES, LTD., Tokyo (JP)

(72) Inventors: Yasuhiro Yamauchi, Tokyo (JP); Katsuhiko Shinoda, Kanagawa (JP); Atsushi Fujii, Tokyo (JP)

(73) Assignee: MITSUBISHI HEAVY INDUSTRIES, LTD., Tokyo (JP)

(21) Appl. No.: 18/998,763

(22) PCT Filed: Oct. 2, 2023
(86) PCT No.: PCT/JP2023/035973

§ 371 Date: Jan. 27, 2025

(30) Foreign Application Priority Data
Oct. 11, 2022 (JP) 2022-163179

(51) Int. Cl. B01D 46/44; B01D 46/42; B01D 46/70

(52) U.S. Cl. CPC B01D 46/446; B01D 46/4263; B01D 46/4272; B01D 46/448; B01D 46/70

(57) ABSTRACT

Provided is a dust collecting unit including: a product gas filter; a cooling hopper; a first discharge valve arranged on an introduction line of the cooling hopper; a second discharge valve arranged on a discharge line of the cooling hopper; a pressurizing unit configured to perform a pressurizing operation of pressurizing a recovery container of the cooling hopper; a depressurizing unit 1 configured to perform a depressurizing operation of depressurizing the recovery container; and a control unit, and after closing the first discharge valve and the second discharge valve and alternatingly repeating the pressurizing operation by the pressurizing unit and the depressurizing operation by the depressurizing unit, the control unit to control the second discharge valve to be opened to discharge, from the discharge line, char recovered in the recovery container.

### TECHNICAL FIELD

The present disclosure relates to a powder recovery device and a control method of a powder recovery device.

### BACKGROUND ART

Ash treatment devices that reduce the temperature of ash recovered from a combustion gas by an ash collecting device and discharge the cooled ash out of the system are conventionally known (for example, see Patent Literature 1). An ash treatment device disclosed in Patent Literature 1 uses an ash cooler to cool ash collected from a high-pressure, high-temperature combustion gas containing ash and transports the cooled ash to a high-pressure ash storage tank. The ash accumulated on the bottom of the high-pressure ash storage tank is swiped out to a depressurizing hopper and delivered to an ash silo after decompressed to the atmospheric pressure.

### CITATION LIST

### Patent Literature

### [PTL 1]

Japanese Patent Application Laid-Open No. H7-42910

### SUMMARY OF INVENTION

### Technical Problem

In Patent Literature 1, however, since an ash cooler is required as a facility for reducing the temperature of ash recovered by the ash recovery device, the installation cost of the ash recovery device is increased, and an installation space for installing the ash cooler is required. Further, when a flammable gas has been adsorbed in pores of particles of ash collected by the ash recovery device, ash containing unburned residuals discharged from the ash recovery device may be oxidized to generate heat (spontaneous generation of heat), or the flammable gas may be desorbed from the ash to contaminate the outside air.

The present disclosure has been made in view of such circumstances and intends to provide a powder recovery device and a control method of a powder recovery device that can separate and cool powder from a heated treatment target gas while suppressing increase in the installation cost and the installation space, spontaneous generation of heat from powder, and contamination of the outside air.

### Solution to Problem

To solve the above problem, the present disclosure employs the following solutions. A powder recovery device according to the present disclosure is a powder recovery device configured to separate powder from a heated treatment target gas and recover the powder, the powder recovery device includes: a powder separating unit configured to separate the powder from the treatment target gas, the treatment target gas being introduced to the powder separating unit; a first recovery unit having an introduction section, the powder separated from the powder separating unit being introduced to the introduction section, a recovery container for temporarily recovering the powder introduced from the introduction section, and a discharge section for discharging the powder recovered in the recovery container; a first on-off valve installed on the introduction section; a second on-off valve installed on the discharge section; a pressurizing unit configured to perform a pressurizing operation of supplying a pressurizing gas to the recovery container to pressurize the recovery container; a depressurizing unit configured to perform a depressurizing operation of discharging the pressurizing gas from the recovery container to outside to depressurize the recovery container; and a control unit configured to control the first on-off valve, the second on-off valve, the pressurizing unit, and the depressurizing unit, and after closing the first on-off valve and the second on-off valve and alternatingly repeating the pressurizing operation performed by the pressurizing unit and the depressurizing operation performed by the depressurizing unit, the control unit controls the second on-off valve to be opened to discharge, from the discharge section, the powder recovered in the recovery container.

A control method of a powder recovery device according to the present disclosure is a control method of a powder recovery device configured to separate powder from a heated treatment target gas and recover the powder, the powder recovery device includes a powder separating unit configured to separate the powder from the treatment target gas, the treatment target gas being introduced to the powder separating unit, a first recovery unit having an introduction section, the powder separated from the powder separating unit being introduced to the introduction section, a recovery container for temporarily recovering the powder introduced from the introduction section, and a discharge section for discharging the powder recovered in the recovery container, a first on-off valve installed on the introduction section, a second on-off valve installed on the discharge section, a pressurizing unit configured to perform a pressurizing operation of supplying a pressurizing gas to the recovery container to pressurize the recovery container, and a depressurizing unit configured to perform a depressurizing operation of discharging the pressurizing gas from the recovery container to outside to depressurize the recovery container, and the control method includes: a pressurizing step of closing the first on-off valve and the second on-off valve and performing the pressurizing operation; a depressurizing step of closing the first on-off valve and the second on-off valve and performing the depressurizing operation by the depressurizing unit; and a discharge step of, after alternatingly repeating the pressurizing step and the depressurizing step, opening the second on-off valve to discharge, from the discharge section, the powder recovered in the recovery container.

### Advantageous Effects of Invention

According to the present disclosure, it is possible to provide a powder recovery device and a control method of a powder recovery device that can separate and cool powder from a heated treatment target gas while suppressing increase in the installation cost and the installation space, spontaneous generation of heat of powder, and contamination of the outside air.

### BRIEF DESCRIPTION OF DRAWINGS

FIG. 1 is a schematic configuration diagram illustrating a biomass gasification unit according to one embodiment of the present disclosure.

FIG. 2 is a schematic configuration diagram illustrating a system configuration of a dust collecting unit illustrated in FIG. 1.

FIG. 3 is a flowchart illustrating a control method of the dust collecting unit of the present embodiment.

FIG. 4 is a graph illustrating a relationship between the time to perform repetition of a pressurizing operation and a depressurizing operation and the temperature of char inside a cooling hopper.

FIG. 5 is a graph illustrating a relationship between the time to perform repetition of a pressurization operation and a depressurization operation and the dilution rate of a gas inside the cooling hopper.

FIG. 6 is a graph illustrating a relationship between the pressure ratio of a first internal pressure relative to a second internal pressure and the cooling time of char inside the cooling hopper.

### DESCRIPTION OF EMBODIMENTS

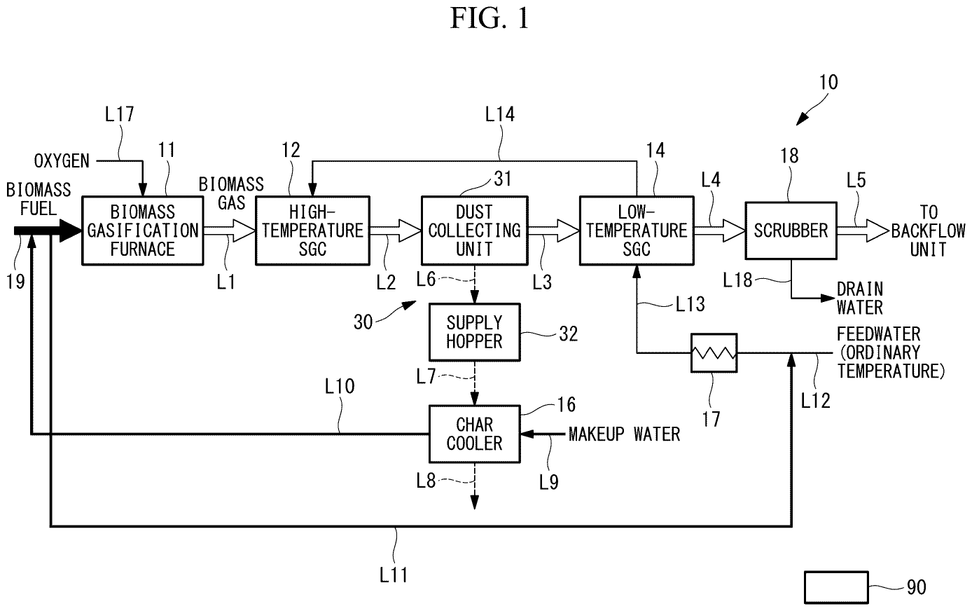

A biomass gasification unit 10 according to one embodiment of the present disclosure will be described below with reference to FIG. 1. The biomass gasification unit 10 according to the present embodiment is a device that partially combusts and gasifies biomass fuel to produce a combustible biomass gas. The biomass fuel is a renewable organic resource of biological origin, for example, thinned wood, waste wood, driftwood, grasses, waste, sludge, and recycle fuel made from these materials (pellets or chips), or the like, and is not limited to those presented here. Since biomass fuel takes in carbon dioxide during the biomass growth process and thus is carbon neutral fuel that does not emit carbon dioxide serving as a global warming gas, various uses of the biomass fuel are under consideration.

As illustrated in FIG. 1, the biomass gasification unit 10 includes a biomass gasifier 11 that produces a biomass gas, a high-temperature synthesis gas cooler 12 (high-temperature SGC) to which the biomass gas discharged from the biomass gasifier 11 is guided, a char recovery unit 30 that recovers char contained in the biomass gas (in which unburned carbon and ash are primary components), a char cooler (heat exchanger) 16 that cools the recovered char, a low-temperature synthesis gas cooler 14 (low-temperature SGC) to which the char-removed biomass gas is guided, a feedwater preheater 17 that preheats a gasifying agent guided to the low-temperature synthesis gas cooler 14, a scrubber 18 that removes impurities from the biomass gas, and a control unit 90.

The biomass gasifier 11 gasifies biomass fuel supplied by a biomass supply unit 19 to produce a biomass gas. The biomass supply unit 19 has a feeder (not illustrated) that transports biomass fuel to the biomass gasifier 11 and inputs the biomass fuel into the biomass gasifier 11.

The biomass gas produced by the biomass gasifier 11 is guided to the high-temperature synthesis gas cooler 12 via a first biomass gas line L1. An oxygen line L17 is connected to the biomass gasifier 11. In the oxygen line L17, oxygen supplied from an oxygen supply device (not illustrated) flows through.

The high-temperature synthesis gas cooler 12 and the low-temperature synthesis gas cooler 14 perform heat exchange between a biomass gas and feedwater or steam (gasifying agent). The high-temperature synthesis gas cooler 12 and the low-temperature synthesis gas cooler 14 use heat of the biomass gas produced by the biomass gasifier 11 to heat the steam guided to the biomass gasifier 11 as a gasifying agent and cool the biomass gas. The biomass gas discharged from the high-temperature synthesis gas cooler 12 is guided to a dust collecting unit 31 of the char recovery unit 30 via a second biomass gas line L2. The biomass gas discharged from the low-temperature synthesis gas cooler 14 is guided to the scrubber 18 via a fourth biomass gas line L4.

The char recovery unit 30 allows a biomass gas to pass therethrough and recovers char contained in the biomass gas passing therethrough. The char recovery unit 30 includes the dust collecting unit (powder recovery device) 31 and a supply hopper 32. The dust collecting unit 31 can isolate char contained in a product gas produced by the biomass gasifier 11. The biomass gas from which char has been isolated (product gas) is then delivered to the low-temperature synthesis gas cooler 14 via a third biomass gas line L3. The details of the char recovery unit 30 will be described later.

The char isolated by the dust collecting unit 31 is guided to the supply hopper 32 via a first char line L6. The char stored in the supply hopper 32 is discharged from the outlet of the supply hopper 32 at a predetermined timing and guided to the char cooler 16 via a second char line L7.

The char cooler 16 cools char by makeup water. The makeup water (gasifying agent) is guided to the char cooler 16 from a makeup water supply device (not illustrated) via a first makeup water line L9. The cooled char is discharged out of the system via a third char line L8. Makeup water at ordinary temperature is supplied to the char cooler 16 from the makeup water supply device (not illustrated). The makeup water is heated by a plurality of devices including the char cooler 16 and then guided to the biomass supply unit 19 via a second makeup water line L10. The makeup water heated by the biomass supply unit 19 is guided to a first feedwater line L12 via a third makeup water line L11 connected between the biomass supply unit 19 and the feedwater line.

The feedwater preheater 17 heats feedwater by a heat medium. Feedwater at ordinary temperature is supplied to the feedwater preheater 17 from the feedwater supply device (not illustrated). In the feedwater preheater 17, the feedwater is heated by heat exchange with the heat medium and partially or entirely becomes steam. The feedwater is heated up to a temperature that causes no problem in terms of condensation or impurity precipitation in the low-temperature synthesis gas cooler 14. The steam discharged from the feedwater preheater 17 is guided to the low-temperature synthesis gas cooler 14 via a first steam line L13. The steam heated by the low-temperature synthesis gas cooler 14 is guided to the high-temperature synthesis gas cooler 12 via a second steam line L14.

The scrubber 18 removes impurities (for example, tar content, ammonia, or the like) contained in a biomass gas. The impurity and excessive water vapor removed by the scrubber 18 are discharged together with scrubber water as drain water out of the system via a drain water line L18. The biomass gas from which impurities and excessive water vapor have been removed is discharged from the scrubber 18 and guided to a downstream unit via a fifth biomass gas line L5. The downstream unit may be a liquid fuel synthesis unit or the like for providing bio jet fuel or the like as an example.

The control unit 90 is a device that controls each unit of the biomass gasification unit 10 including the char recovery unit 30.

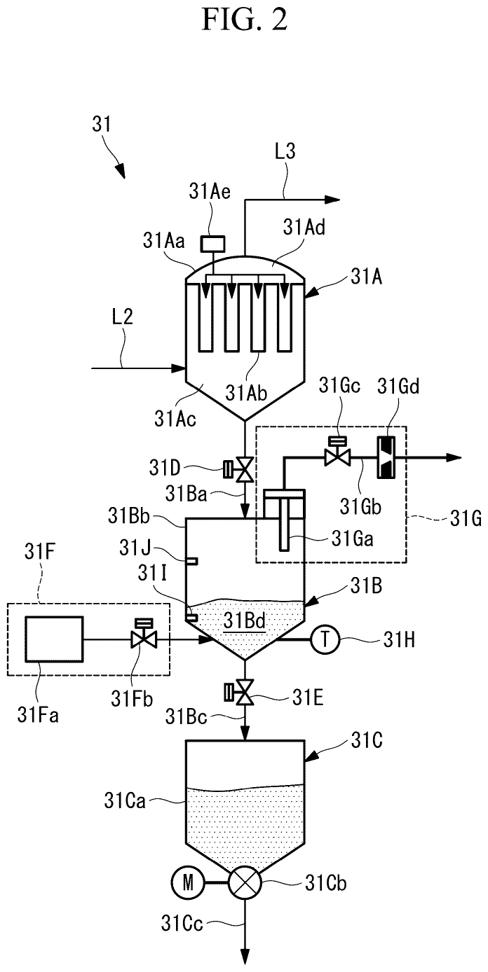

Next, the dust collecting unit 31 of the present embodiment will be described in detail. FIG. 2 is a schematic configuration diagram illustrating the system configuration of the dust collecting unit 31 illustrated in FIG. 1. As illustrated in FIG. 2, the dust collecting unit 31 includes a product gas filter (powder separating unit) 31A, a cooling hopper (first recovery unit) 31B, a discharge hopper 31C, a first discharge valve (first on-off valve) 31D, a second discharge valve (second on-off valve) 31E, a pressurizing unit 31F, a depressurizing unit 31G, a temperature sensor (detecting unit) 31H, a first level sensor 31I, and a second level sensor 31J. As illustrated in FIG. 2, the product gas filter 31A, the cooling hopper 31B, and the discharge hopper 31C are arranged in this order vertically from above.

The product gas filter 31A is a device to which a product gas (treatment target gas) is introduced from the high-temperature synthesis gas cooler 12 via the second biomass gas line L2 and that isolates and recovers char (powder containing unreacted contents of biomass fuel and ash) from the product gas. The product gas supplied to the product gas filter 31A is at a temperature in a range of 300° C. or higher and 500° C. or lower, for example.

The product gas filter 31A has filters 31Ab inside a container 31Aa. Each filter 31Ab is a filter having a large number of pores and is made of, for example, ceramics or sintered metal. The filter 31Ab has a circular, cylindrical shape, for example, and a plurality of filters 31Ab are provided in parallel having an axis vertically. The space inside the container 31Aa is partitioned vertically by the filters 31Ab, the lower space 31Ac is a pre-filtration space into which a product gas containing char flows, and the upper space 31Ad is a post-filtration space.

The second biomass gas line L2 for guiding a product gas containing char is connected to the lower space 31Ac of the product gas filter 31A. The third biomass gas line L3 for guiding the char-isolated product gas to the low-temperature synthesis gas cooler 14 is connected to the upper space 31Ad of the product gas filter 31A.

The product gas filter 31A is provided with a backwash device 31Ae. The backwash device 31Ae injects a backwash gas, which is for backwashing the filters 31Ab and swiping off char attached to the surface on the lower space 31Ac side of the filters 31Ab or the like, from the upper space 31Ad side to the lower space 31Ac side in a pulsed manner (for example, intervals of 0.5 seconds). As the backwash gas, an inert gas such as nitrogen is used.

The cooling hopper 31B is a device that temporarily recovers and cools char discharged from the product gas filter 31A and discharges the char to the discharge hopper 31C. The cooling hopper 31B has an introduction line (introduction section) 31Ba, a recovery container 31Bb, and a discharge line (discharge section) 31Bc. The introduction line 31Ba is a pipe for introducing char isolated from the product gas by the product gas filter 31A to the recovery container 31Bb. The recovery container 31Bb is a container for temporarily recovering char introduced from the introduction line 31Ba. The discharge line 31Bc is a pipe for discharging char recovered in the recovery container 31Bb to the discharge hopper 31C.

The discharge hopper 31C is a device that temporarily recovers char discharged from the cooling hopper 31B and supplies the char to the supply hopper 32. The discharge hopper 31C has a recovery container 31Ca, a rotary feeder 31Cb, and a discharge line 31Cc. The recovery container 31Ca is a container for temporarily recovering char introduced from the discharge line 31Bc. The rotary feeder 31Cb is a device that is rotated by drive force of a motor and thereby guides char from the recovery container 31Ca to the discharge line 31Cc. The discharge line 31Cc is a pipe for supplying the char recovered in the recovery container 31Ca to the supply hopper 32.

The first discharge valve 31D is an on-off valve arranged on the introduction line 31Ba and configured to perform switching between an open state, which provides communication between the internal space of the container 31Aa of the product gas filter 31A and the internal space of the recovery container 31Bb of the cooling hopper 31B, and a closed state, which blocks communication between the internal space of the container 31Aa of the product gas filter 31A and the internal space of the recovery container 31Bb of the cooling hopper 31B.

The second discharge valve 31E is an on-off valve arranged on the discharge line 31Bc and configured to perform switching between an open state, which provides communication between the internal space of the recovery container 31Bb of the cooling hopper 31B and the internal space of the recovery container 31Ca of the discharge hopper 31C to, and a closed state, which blocks communication between the internal space of the recovery container 31Bb of the cooling hopper 31B and the internal space of the recovery container 31Ca of the discharge hopper 31C.

The pressurizing unit 31F is a device that performs a pressurizing operation of supplying a pressurizing gas to the recovery container 31Bb of the cooling hopper 31B to pressurize the internal space to the recovery container 31Bb. The pressurizing unit 31F has a pressurizing gas supply source 31Fa and an on-off valve 31Fb. The on-off valve 31Fb performs switching between an open state, which supplies a pressurizing gas from the pressurizing gas supply source 31Fa to the recovery container 31Bb, and a closed state, which does not supply the pressurizing gas from the pressurizing gas supply source 31Fa to the recovery container 31Bb.

The pressurizing gas is a nitrogen gas, for example, but other inert gasses may be used. For example, a gas that does not cause char to be oxidized and to generate heat due to contact with the char when the oxygen concentration is 10% or less can be used. As illustrated in FIG. 2, the pressurizing unit 31F introduces a pressurizing gas to a recovery region 31Bd in which char is recovered located on the lower side in the recovery container 31Bb of the cooling hopper 31B and stirs the char present in the recovery region 31Bd.

The depressurizing unit 31G is a device that performs a depressurizing operation of discharging a pressurizing gas from the recovery container 31Bb of the cooling hopper 31B to the outside to depressurize the internal space of the recovery container 31Bb. The depressurizing unit 31G has a filter 31Ga, a discharge line 31Gb, an on-off valve 31Gc, and an orifice 31Gd. The depressurizing unit 31G switches the on-off valve 31Gc from the closed state to the open state under a pressurized state where the internal space of the recovery container 31Bb is pressurized to a higher pressure than the atmospheric pressure and thereby discharges the pressurizing gas from the recovery container 31Bb via the discharge line 31Gb.

Note that a product gas (flammable gas) may be contained inside the pores of char recovered in the recovery container 31Bb. In such a case, the pressurizing gas discharged from the recovery container 31Bb to outside (for example, to the atmospheric air) will contain the flammable gas. However, since such a flammable gas is diluted below the environmental standard value and below a flammable range by the pressurizing gas, contamination of the surrounding environment is suppressed. Further, to treat a flammable gas contained in the pressurizing gas, the discharge line 31Gb may be connected to a treatment device (not illustrated) such as a ground flare or a flare stack to combust the flammable gas.

The filter 31Ga is a filter having a large number of pores and is made of, for example, ceramics or sintered metal. The filter 31Ga has a circular, cylindrical shape, for example. Although the depressurizing unit 31G illustrated in FIG. 2 has a single filter 31Ga, the depressurizing unit 31G may have a plurality of filters 31Ga.

The discharge line 31Gb is a pipe for externally guiding the pressurizing gas from which char has been removed when the char passes through the filter 31Ga. The on-off valve 31Gc and the orifice 31Gd are installed on the discharge line 31Gb.

The on-off valve 31Gc is a device that performs switching between an open state, which provides communication between the internal space of the recovery container 31Bb and the outside via the discharge line 31Gb, and a closed state, which blocks communication between the internal space of the recovery container 31Bb and the outside via the discharge line 31Gb.

The orifice 31Gd is a device for limiting the flow rate of the pressurizing gas flowing through the discharge line 31Gb per unit time when the on-off valve 31Gc is in the open state. The orifice 31Gd defines the maximum value of the flow rate of the pressurizing gas flowing through the discharge line 31Gb per unit time by setting the flow channel sectional area to a predetermined value set in advance.

The temperature sensor 31H is a device that measures the temperature of char recovered in the recovery region 31Bd of the recovery container 31Bb of the cooling hopper 31B. The temperature sensor 31H transfers the measured temperature of char to the control unit 90.

The first level sensor 31I is a sensor that detects whether or not the accumulated height of char recovered in the recovery container 31Bb of the cooling hopper 31B reaches a first predetermined height. The second level sensor 31J is a sensor that detects whether or not the accumulated height of char recovered in the recovery container 31Bb of the cooling hopper 31B reaches a second predetermined height, which is higher than the first predetermined height. In the state illustrated in FIG. 2, the first level sensor 31I detects that the char accumulated height reaches the first predetermined height, and the second level sensor 31J does not detect that the char accumulated height reaches the second predetermined height.

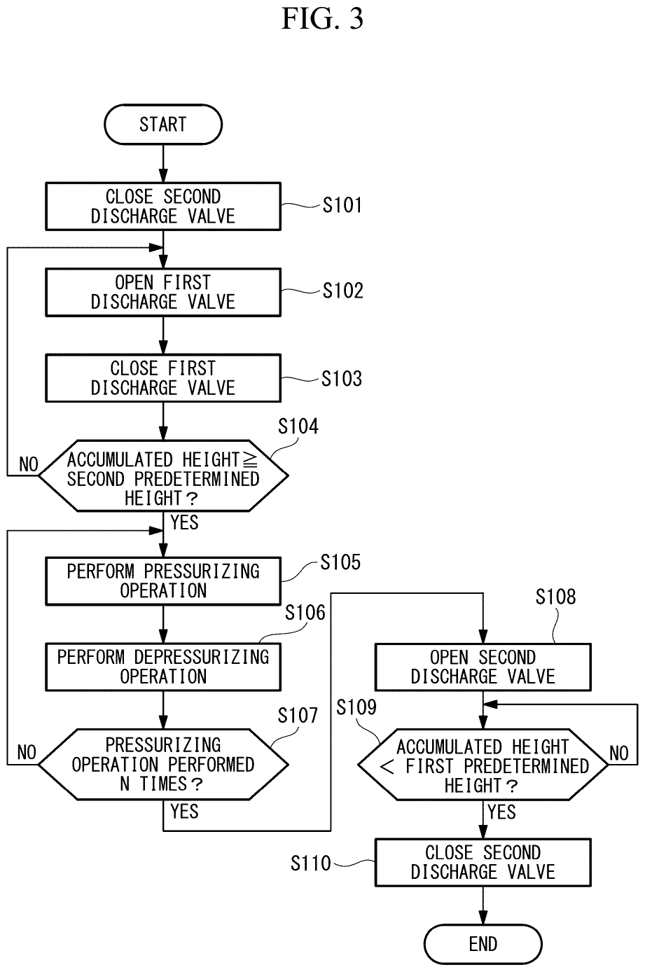

Next, the control method of the dust collecting unit 31 of the present embodiment will be described with reference to FIG. 3. FIG. 3 is a flowchart illustrating the control method of the dust collecting unit 31 of the present embodiment. Each process of the flowchart of FIG. 3 is performed when the control unit 90 executes a control program stored in the storage unit (not illustrated). The control unit 90 controls the first discharge valve 31D, the second discharge valve 31E, the pressurizing unit 31F, and the depressurizing unit 31G in each process of the flowchart illustrated in FIG. 3.

In step S101, the control unit 90 controls the second discharge valve 31E installed on the discharge line 31Bc to be closed. When the second discharge valve 31E is in the closed state, the cooling hopper 31B and the discharge hopper 31C are not in communication with each other.

In step S102, the control unit 90 controls the first discharge valve 31D installed on the introduction line 31Ba to be opened. When the first discharge valve 31D is in the open state, the product gas filter 31A and the cooling hopper 31B are in communication with each other, and char is supplied from the product gas filter 31A to the cooling hopper 31B.

In step S103, in response to passage of a predetermined time after the first discharge valve 31D is opened in step S102, the control unit 90 controls the first discharge valve 31D installed on the introduction line 31Ba to be closed. When the first discharge valve 31D is in the closed state, the product gas filter 31A and the cooling hopper 31B are not in communication with each other, and char supply from the product gas filter 31A to the cooling hopper 31B is stopped.

In step S104, the control unit 90 determines whether or not the accumulated height that the char recovered in the cooling hopper 31B is accumulated in the recovery container 31Bb is greater than or equal to the second predetermined height, and if the accumulated height is greater than or equal to the second predetermined height, proceeds with the process to step S105. When the second level sensor 31J detects that the char accumulated height reaches the second predetermined height, the control unit 90 determines YES in step S104. If the determination is NO in step S104, the control unit 90 repeats the process of step S102 and step S103 until the determination becomes YES in step S104.

In step S105, the control unit 90 closes the first discharge valve 31D and the second discharge valve 31E to form a closed space in the recovery container 31Bb and performs a pressurizing operation to supply a pressurizing gas to the recovery container 31Bb to pressurize the internal space of the recovery container 31Bb. The control unit 90 opens the on-off valve 31Fb until the pressure of the internal space of the recovery container 31Bb reaches a first internal pressure, which is higher than the atmospheric pressure, and closes the on-off valve 31Fb in response to the pressure of the internal space of the recovery container 31Bb reaching the first internal pressure.

For example, the control unit 90 measures the pressure of the internal space of the recovery container 31Bb by a pressure sensor (not illustrated) to determine whether or not the pressure of the internal space of the recovery container 31Bb reaches the first internal pressure. The control unit 90 may set a set time in advance during which the on-off valve 31Fb is to be opened until the pressure of the internal space of the recovery container 31Bb reaches the first internal pressure from the atmospheric pressure and, in response to passage of the set time after the on-off valve 31Fb is opened, may determine that the pressure of the internal space of the recovery container 31Bb reaches the first internal pressure.

In step S106, the control unit 90 closes the first discharge valve 31D and the second discharge valve 31E to form a closed space in the recovery container 31Bb and performs a depressurizing operation to discharge the pressurizing gas from the recovery container 31Bb to depressurize the internal space of the recovery container 31Bb. The control unit 90 opens the on-off valve 31Gc until the pressure of the internal space of the recovery container 31Bb reaches a second internal pressure (for example, the atmospheric pressure), which is lower than the first internal pressure, from the first internal pressure and closes the on-off valve 31Gc in response to the pressure of the internal space of the recovery container 31Bb reaching the second internal pressure.

For example, the control unit 90 measures the pressure of the internal space of the recovery container 31Bb by a pressure sensor (not illustrated) to determine whether or not the pressure of the internal space of the recovery container 31Bb reaches the second internal pressure. The control unit 90 may set a set time in advance during which the on-off valve 31Gc is to be opened until the pressure of the internal space of the recovery container 31Bb reaches the second internal pressure from the first internal pressure and, in response to passage of the set time after the on-off valve 31Gc is opened, may determine that the pressure of the internal space of the recovery container 31Bb reaches the second internal pressure.

In step S107, the control unit 90 determines whether or not the pressurizing operation of step S105 and the depressurizing operation of step S106 have been performed N times (N is an integer greater than or equal to two), respectively. If the determination is YES, the control unit 90 proceeds with the process to step S108, or if the determination is NO, the control unit 90 repeats the pressurizing operation of step S105 and the depressurizing operation of step S106 until the determination becomes YES in step S107. That is, the control unit 90 alternatingly, repeatedly performs the pressurizing operation and the depressurizing operation each for N times and then proceeds with the process to step S108.

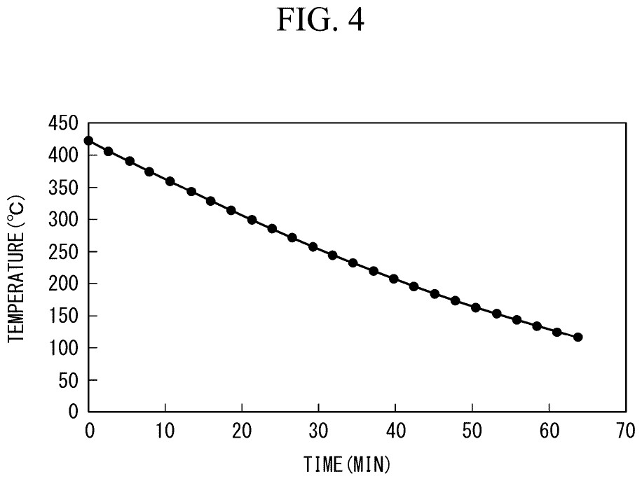

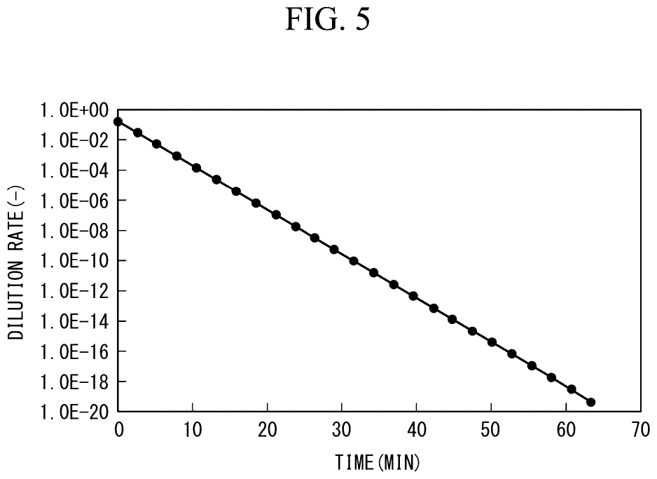

The reason for alternatingly repeating the pressurizing operation and the depressurizing operation each for N times will now be described with reference to FIG. 4 and FIG. 5. FIG. 4 is a graph illustrating the relationship between the time to repeatedly perform the pressurization operation and the depressurization operation and the temperature of char inside the cooling hopper. FIG. 5 is a graph illustrating the relationship between the time to perform repetition of the pressurization operation and the depressurization operation and the dilution rate of a gas inside the cooling hopper.

The example illustrated in FIG. 4 represents an example in which the pressurizing operation for 40 seconds and the depressurizing operation for 120 seconds are repeated when the initial temperature of char recovered in the cooling hopper 31B is 420° C., the volume of the internal space of the cooling hopper 31B is 2 m², and the weight of char reaching the second predetermined height in the cooling hopper 31B is 50 Kg. The plots illustrated in FIG. 4 indicate timings to start pressurizing operations, and the interval between the plots is 160 seconds that are the time of performing a pressurizing operation and a depressurizing operation.

As illustrated in FIG. 4, since the pressurizing operation and the depressurizing operation are repeated and thereby the pressurizing gas to which heat of char has been transferred is discharged to the outside, the temperature of char gradually decreases. In the example illustrated in FIG. 4, a set of operation made up of one pressurizing operation and one depressurizing operation is repeated for 21 times, and thereby the temperature of char decreases from 420° C. to a temperature less than the natural oxidization temperature (for example, 150° C.).

For example, when the target temperature of char after cooled inside the cooling hopper 31B is less than 150° C., 21 is set for N in step S107. After alternatingly repeating the pressurizing operation performed by the pressurizing unit 31F and the depressurizing operation performed by the depressurizing unit 31G for N times so that the temperature of char inside the cooling hopper 31B becomes less than 150° C. in step S105 to step S107, the control unit 90 discharges the char from the cooling hopper 31B to the discharge hopper 31C.

Note that, although, in step S107, it is determined that the temperature of char inside the cooling hopper 31B becomes less than 150° C. based on N-time repetition of the pressurizing operation and the depressurizing operation, other forms may be employed. For example, in response to the temperature of char measured by the temperature sensor 31H becoming less than 150° C., the control unit 90 may stop the pressurizing/depressurizing operation to enter step S108 and open the second discharge valve 31E to discharge char recovered in the recovery container 31Bb of the cooling hopper 31B from the discharge line 31Bc.

As illustrated in FIG. 5, the pressurizing gas remaining inside the cooling hopper 31B after depressurized is diluted with the pressurizing gas newly introduced from the pressurizing unit 31F. Thus, with the repetition of the pressurizing operation and the depressurizing operation, the dilution rate gradually decreases (the dilution factor gradually increases). Thus, the concentration of the flammable gas present inside the cooling hopper 31B after the pressurizing operation and the depressurizing operation are repeated N times becomes below the flammable range and below the environmental standard value and becomes such a concentration that does not cause ignition or contamination even when the flammable gas is discharged to the outside.

In step S108, after alternatingly repeating the pressurizing operation performed by the pressurizing unit 31F and the depressurizing operation performed by the depressurizing unit 31G for N times, the control unit 90 controls the second discharge valve 31E to be opened to discharge the char recovered in the recovery container 31Bb of the cooling hopper 31B from the discharge line 31Bc to the discharge hopper 31C.

In step S109, the control unit 90 determines whether or not the accumulated height that the char recovered in the cooling hopper 31B is accumulated in the recovery container 31Bb is less than the first predetermined height, and if the accumulated height is less than the first predetermined height, proceeds with the process to step S110. When the first level sensor 31I detects that the char accumulated height is less than the first predetermined height, the control unit 90 determines YES in step S109. If the determination is NO in step S109, the control unit 90 repeats the process of step S109 until the determination becomes YES in step S109.

In step S110, since the accumulated height that the char recovered in the cooling hopper 31B is accumulated in the recovery container 31Bb is less than the first predetermined height, the control unit 90 controls the second discharge valve 31E to be closed to stop discharge of char from the recovery container 31Bb of the cooling hopper 31B to the discharge hopper 31C. The control unit 90 ends the process of the present flowchart after performing step S110.

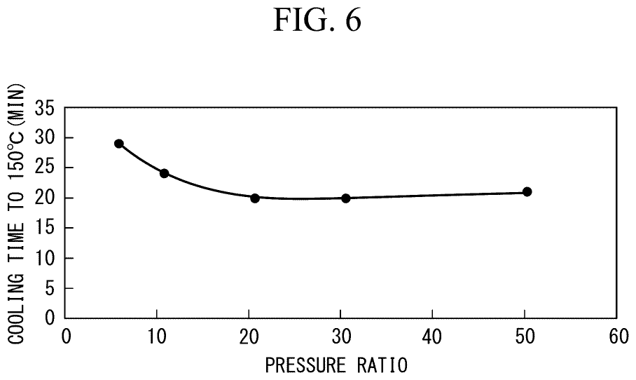

The first internal pressure in the pressurizing operation of step S105 will now be described. It is preferable to set the first internal pressure to be less than 20 times of the second internal pressure. FIG. 6 is a graph illustrating the relationship between the pressure ratio that is a ratio of the first internal pressure relative to the second internal pressure (the first internal pressure/the second internal pressure) and the cooling time of char inside the cooling hopper 31B. The cooling time is the time required for char inside the cooling hopper 31B to decrease from 420° C., which is the initial temperature, to 150°.

As illustrated in FIG. 6, in the region where the pressure ratio exceeds 20, there is little change in the cooling time even when the pressure ratio is increased. Therefore, increasing the pressure ratio to be greater than 20 has little effect on reducing the cooling time. Thus, in the present embodiment, the first internal pressure is set to be 20 times or less of the second internal pressure.

In the present embodiment, with the use of repetition of the pressurizing operation performed by the pressurizing unit 31F and the depressurizing operation performed by the depressurizing unit 31G, char is cooled by heat transfer from the char to the pressurizing gas and by discharge of the heat-transferred pressurizing gas. The temperature of char before one time of the pressurizing operation and one time of the depressurizing operation are performed is denoted as T1, the temperature of char after one time of the pressurizing operation and one time of the depressurizing operation are performed is denoted as T2, and T1 and T2 satisfy Equation (1) below. The pressurizing gas is a nitrogen gas.

$$a \times T {2}^{2} + b \times T 2 + c \qquad ( 1 )$$

Herein, a, b, and c are coefficients expressed by Equations (2), (3), and (4) below.

$$a = Cpm \times G \qquad ( 2 )$$

$$b = {CpN}_{2} \times ρ {N}_{2} \times V \times [ ( P 1 - P 2 ) / P 0 ] \times Ts - T 1 \times Cpm \times G \qquad ( 3 )$$

$$c = - T 0 \times {CpN}_{2} \times ρ {N}_{2} \times V \times [ ( P 1 - P 2 ) / P 0 ] \times Ts \qquad ( 4 )$$

Herein, Cpm is the specific heat [kJ/kg·K] of char, and G is the weight [kg] of char. Further, CpN₂ is the specific heat [kJ/kg·K] of the nitrogen gas, ρN₂ is the specific gravity [kg/m³] of the nitrogen gas, V is the volume [m³] of the internal space of the cooling hopper 31B, P1 is the first internal pressure [kPa], and P2 is the second internal pressure [kPa]. Further, Ts is the standard temperature of 273.14 [K], and T0 is the temperature [K] of the nitrogen gas supplied to the cooling hopper 31B.

The powder recovery device and the control method of the powder recovery device according to each embodiment described above are understood as follows, for example.

The powder recovery device according to the first aspect of the present disclosure is a powder recovery device (31) configured to separate powder from a heated treatment target gas and recover the powder, the powder recovery device includes: a powder separating unit (31A) configured to separate the powder from the treatment target gas, the treatment target gas being introduced to the powder separating unit; a first recovery unit (31B) having an introduction section (31Ba), the powder separated from the powder separating unit being introduced to the introduction section, a recovery container (31Bb) for temporarily recovering the powder introduced from the introduction section, and a discharge section (31Bc) for discharging the powder recovered in the recovery container; a first on-off valve (31D) installed on the introduction section; a second on-off valve (31E) installed on the discharge section; a pressurizing unit (31F) configured to perform a pressurizing operation of supplying a pressurizing gas to the recovery container to pressurize the recovery container; a depressurizing unit (31G) configured to perform a depressurizing operation of discharging the pressurizing gas from the recovery container to outside to depressurize the recovery container; and a control unit (90) configured to control the first on-off valve, the second on-off valve, the pressurizing unit, and the depressurizing unit, and after closing the first on-off valve and the second on-off valve and alternatingly repeating the pressurizing operation performed by the pressurizing unit and the depressurizing operation performed by the depressurizing unit, the control unit controls the second on-off valve to be opened to discharge, from the discharge section, the powder recovered in the recovery container.

According to the powder recovery device of the first aspect of the present disclosure, powder is separated from the treatment target gas heated in the powder separating unit, introduced to the introduction section of the first recovery unit, temporarily stored in the recovery container, and then discharged from the discharge section. The first on-off valve is installed on the introduction section, the second on-off valve is installed on the discharge section, and the first on-off valve and the second on-off valve are closed to form a closed space in the recovery container of the first recovery unit. The recovery container is pressurized with the pressurizing gas by the pressurizing unit performing the pressurizing operation and is depressurized by the depressurizing unit performing the depressurizing operation to discharge the pressurizing gas.

According to the powder recovery device of the first aspect of the present disclosure, the control unit controls the first on-off valve and the second on-off valve to be closed and alternatingly repeat the pressurizing operation performed by the pressurizing unit and the depressurizing operation performed by the depressurizing unit. The repetition of the pressurizing operation and the depressurizing operation causes the pressurizing gas having heat transferred from powder inside the recovery container to be substituted multiple times, and the powder is gradually cooled.

As described above, according to the powder recovery device of the first aspect of the present disclosure, since it is possible to cool powder without providing a separate cooler, it is possible to prevent an increase in the installation cost and the installation space of the powder recovery device. Further, since a flammable gas or the like adsorbed to powder when the pressurizing gas inside the recovery container is substituted multiple times can be discharged to outside while diluted with the pressurizing gas, ignition or contamination of the outside air can be prevented.

The powder recovery device according to the second aspect of the present disclosure further includes the following configuration in the first aspect. That is, the control unit controls the pressurizing unit and the depressurizing unit so that a first internal pressure of the recovery container pressurized by the pressurizing operation is 20 times or less of a second internal pressure of the recovery container depressurized by the depressurizing operation.

According to the powder recovery device of the second aspect of the present disclosure, the recovery container is pressurized by the pressurization operation, and this enables cooling of the powder recovered in the recovery container and dilution of a flammable gas or the like adsorbed to the powder to be reliably performed. Further, the first internal pressure of the recovery container pressurized by the pressurizing operation is 20 times or less of the second internal pressure of the recovery container depressurized by the depressurizing operation, and this can prevent the first internal pressure of the recovery container from being excessively increased to such a pressure that is unnecessary for cooling of the powder or dilution of the flammable gas or the like adsorbed to the powder.

The powder recovery device according to the third aspect of the present disclosure further includes the following configuration in the first aspect or the second aspect. That is, after alternatingly repeating the pressurizing operation performed by the pressurizing unit and the depressurizing operation performed by the depressurizing unit so that the temperature of the powder becomes lower than a natural oxidization temperature, the control unit controls the second on-off valve to be opened to discharge, from the discharge section, the powder recovered in the recovery container.

According to the powder recovery device of the third aspect of the present disclosure, since the powder recovered in the recovery container is discharged after the temperature thereof has become lower than the natural oxidization temperature, it is possible to suitably prevent the powder discharged at the natural oxidization temperature or higher from being naturally oxidized in the atmospheric air.

The powder recovery device according to the fourth aspect of the present disclosure further includes the following configuration in the third aspect. That is, the powder recovery device includes a detecting unit (31H) configured to measure the temperature of the powder recovered, and in response to the temperature of the powder measured by the detecting unit becoming lower than the natural oxidization temperature, the control unit controls the second on-off valve to be opened to discharge, from the discharge section, the powder recovered in the recovery container.

According to the powder recovery device of the fourth aspect of the present disclosure, the powder can be discharged from the recovery container in response to the detecting unit detecting that the temperature of the powder became less than the natural oxidization temperature.

The powder recovery device according to the fifth aspect of the present disclosure further includes the following configuration in the third aspect. That is, after performing the pressurizing operation performed by the pressurizing unit and the depressurizing operation performed by the depressurizing unit for a predetermined number of times, respectively, the control unit controls the second on-off valve to be opened to discharge, from the discharge section, the powder recovered in the recovery container.

According to the powder recovery device of the fifth aspect of the present disclosure, the number of times of repetition of the pressurizing operation and the depressurizing operation required to reduce the temperature of the powder to be less than the natural oxidization temperature is set to a predetermined number of times, and the powder at a temperature lower than the natural oxidization temperature can be discharged from the recovery container after the pressurizing operation and the depressurizing operation are performed the predetermined number of times.

In the powder recovery device according to the sixth aspect of the present disclosure, in the first aspect or the second aspect, the pressurizing gas is a gas having an oxygen concentration of 10% or less.

According to the powder recovery device of the sixth aspect of the present disclosure, because a gas having an oxygen concentration of 10% or less is introduced to the recovery container, it is possible to reliably prevent the powder at a high temperature contacted with the gas inside the recovery container from being naturally oxidized.

In the powder recovery device according to the seventh aspect of the present disclosure, in the sixth aspect, the pressurizing gas is a nitrogen gas.

According to the powder recovery device of the seventh aspect of the present disclosure, because a nitrogen gas is introduced to the recovery container, it is possible to reliably prevent the powder at a high temperature contacted with the gas inside the recovery container from being naturally oxidized.

The powder recovery device according to the eighth aspect of the present disclosure further includes the following configuration in the first aspect or the second aspect. That is, the pressurizing unit introduces the pressurizing gas to a recovery region (31Bd) on the lower side in the recovery container, the powder being recovered in the recovery region.

According to the powder recovery device of the eighth aspect of the present disclosure, since the pressurizing gas is introduced to the recovery region in which the powder is recovered located on the lower side in the recovery container, the powder is stirred by the pressurizing gas, and the heat of the powder can be effectively transferred to the pressurizing gas.

The control method of the powder recovery device according to the ninth aspect of the present disclosure is a control method of a powder recovery device configured to separate powder from a heated treatment target gas and recover the powder, wherein the powder recovery device includes a powder separating unit configured to separate the powder from the treatment target gas, the treatment target gas being introduced to the powder separating unit, a first recovery unit having an introduction section, the powder separated from the powder separating unit being introduced to the introduction section, a recovery container for temporarily recovering the powder introduced from the introduction section, and a discharge section for discharging the powder recovered in the recovery container, a first on-off valve installed on the introduction section, a second on-off valve installed on the discharge section, a pressurizing unit configured to perform a pressurizing operation of supplying a pressurizing gas to the recovery container to pressurize the recovery container, and a depressurizing unit configured to perform a depressurizing operation of discharging the pressurizing gas from the recovery container to outside to depressurize the recovery container, and the control method includes: a pressurizing step (S105) of closing the first on-off valve and the second on-off valve and performing the pressurizing operation; a depressurizing step (S106) of closing the first on-off valve and the second on-off valve and performing the depressurizing operation by the depressurizing unit; and a discharge step (S108) of, after alternatingly repeating the pressurizing step and the depressurizing step, opening the second on-off valve to discharge, from the discharge section, the powder recovered in the recovery container.

According to the control method of the powder recovery device of the ninth aspect of the present disclosure, powder is separated from the treatment target gas heated in the powder separating unit, introduced to the introduction section of the first recovery unit, temporarily stored in the recovery container, and then discharged from the discharge section. The first on-off valve is installed on the introduction section, the second on-off valve is installed on the discharge section, and the first on-off valve and the second on-off valve are closed to form a closed space in the recovery container of the first recovery unit. The recovery container is pressurized with the pressurizing gas by the pressurizing unit performing the pressurizing operation and is depressurized by the depressurizing unit performing the depressurizing operation to discharge the pressurizing gas.

According to the control method of the powder recovery device of the ninth aspect of the present disclosure, in the discharge step, the first on-off valve and the second on-off valve are closed, and the pressurizing step and the depressurizing step are alternatingly repeated. The repetition of the pressurizing operation and the depressurizing operation causes the pressurizing gas heat-transferred from powder inside the recovery container to be substituted multiple times, and the powder is gradually cooled.

A described above, according to the control method of the powder recovery device of the ninth aspect of the present disclosure, since it is possible to cool powder without providing a separate cooler, it is possible to prevent an increase in the installation cost and the installation space of the powder recovery device. Further, since a flammable gas or the like adsorbed to powder when the pressurizing gas inside the recovery container is substituted multiple times can be discharged to outside while diluted with the pressurizing gas, ignition or contamination of the outside air can be prevented.

[Reference Signs List]

| | |
|---|---|
| 10 | biomass gasification unit |
| 11 | biomass gasifier |
| 12 | high-temperature synthesis gas cooler |
| 14 | low-temperature synthesis gas cooler |
| 16 | char cooler |
| 17 | feedwater preheater |
| 18 | scrubber |
| 30 | char recovery unit |
| 31 | dust collecting unit (powder recovery device) |
| 31A | product gas filter (powder separating unit) |
| 31Aa | container |
| 31Ab | filter |
| 31Ac | lower space |
| 31Ad | upper space |
| 31Ae | backwash device |
| 31B | cooling hopper (first recovery unit) |
| 31Ba | introduction line (introduction section) |
| 31Bb | recovery container |
| 31Bc | discharge line (discharge section) |
| 31Bd | recovery region |
| 31C | discharge hopper (second recovery unit) |
| 31Ca | recovery container |
| 31Cb | rotary feeder |
| 31Cc | discharge line |
| 31D | first discharge valve (first on-off valve) |
| 31E | second discharge valve (second on-off valve) |
| 31F | pressurizing unit |
| 31Fa | pressurizing gas supply source |
| 31Fb | on-off valve |
| 31G | depressurizing unit |
| 31Ga | filter |
| 31Gb | discharge line |
| 31Gc | ou-off valve |
| 31Gd | orifice |
| 31H | temperature sensor (detecting unit) |
| 31I | first level sensor |
| 31J | second level sensor |
| 32 | supply hopper |
| 90 | control unit |

1. A powder recovery device configured to separate powder from a heated treatment target gas and recover the powder, the powder recovery device comprising:
a powder separating unit configured to separate the powder from the treatment target gas, the treatment target gas being introduced to the powder separating unit;
a first recovery unit having an introduction section, the powder separated from the powder separating unit being introduced to the introduction section, a recovery container for temporarily recovering the powder introduced from the introduction section, and a discharge section for discharging the powder recovered in the recovery container;
a first on-off valve installed on the introduction section;
a second on-off valve installed on the discharge section;
a pressurizing unit configured to perform a pressurizing operation of supplying a pressurizing gas to the recovery container to pressurize the recovery container;
a depressurizing unit configured to perform a depressurizing operation of discharging the pressurizing gas from the recovery container to outside to depressurize the recovery container; and
a control unit configured to control the first on-off valve, the second on-off valve, the pressurizing unit, and the depressurizing unit,
wherein after closing the first on-off valve and the second on-off valve and alternatingly repeating the pressurizing operation performed by the pressurizing unit and the depressurizing operation performed by the depressurizing unit, the control unit controls the second on-off valve to be opened to discharge, from the discharge section, the powder recovered in the recovery container.

2. The powder recovery device according to claim 1, wherein the control unit controls the pressurizing unit and the depressurizing unit so that a first internal pressure of the recovery container pressurized by the pressurizing operation is 20 times or less of a second internal pressure of the recovery container depressurized by the depressurizing operation.

3. The powder recovery device according to claim 1, wherein after alternatingly repeating the pressurizing operation performed by the pressurizing unit and the depressurizing operation performed by the depressurizing unit so that the temperature of the powder becomes lower than a natural oxidization temperature, the control unit controls the second on-off valve to be opened to discharge, from the discharge section, the powder recovered in the recovery container.

4. The powder recovery device according to claim 3 further comprising a detecting unit configured to measure the temperature of the powder recovered in the recovery container,
wherein in response to the temperature of the powder measured by the detecting unit becoming lower than the natural oxidization temperature, the control unit controls the second on-off valve to be opened to discharge, from the discharge section, the powder recovered in the recovery container.

5. The powder recovery device according to claim 3, wherein after performing the pressurizing operation performed by the pressurizing unit and the depressurizing operation performed by the depressurizing unit for a predetermined number of times, respectively, the control unit controls the second on-off valve to be opened to discharge, from the discharge section, the powder recovered in the recovery container.

6. The powder recovery device according to claim 1, wherein the pressurizing gas is a gas having an oxygen concentration of 10% or less.

7. The powder recovery device according to claim 6, wherein the pressurizing gas is a nitrogen gas.

8. The powder recovery device according to claim 1, wherein the pressurizing unit introduces the pressurizing gas to a recovery region on the lower side in the recovery container, the powder being recovered in the recovery region.

9. A control method of a powder recovery device configured to separate powder from a heated treatment target gas and recover the powder, wherein the powder recovery device comprises
a powder separating unit configured to separate the powder from the treatment target gas, the treatment target gas being introduced to the powder separating unit,
a first recovery unit having an introduction section, the powder separated from the powder separating unit being introduced to the introduction section, a recovery container for temporarily recovering the powder introduced from the introduction section, and a discharge section for discharging the powder recovered in the recovery container,
a first on-off valve installed on the introduction section,
a second on-off valve installed on the discharge section,
a pressurizing unit configured to perform a pressurizing operation of supplying a pressurizing gas to the recovery container to pressurize the recovery container, and
a depressurizing unit configured to perform a depressurizing operation of discharging the pressurizing gas from the recovery container to outside to depressurize the recovery container,
the control method comprising:
a pressurizing step of closing the first on-off valve and the second on-off valve and performing the pressurizing operation;
a depressurizing step of closing the first on-off valve and the second on-off valve and performing the depressurizing operation by the depressurizing unit; and
a discharge step of, after alternatingly repeating the pressurizing step and the depressurizing step, opening the second on-off valve to discharge, from the discharge section, the powder recovered in the recovery container.
